(19) United States
(12) Patent Application Publication
(10) Pub. No.: US 2008/0043279 A1
(43) Pub. Date: Feb. 21, 2008

(54) Sheet handling device and process

(76) Inventor: Valentinis Francesco, Chiaverano (TO) (IT)

Correspondence Address: YOUNG & THOMPSON, 745 SOUTH 23RD STREET, 2ND FLOOR, ARLINGTON, VA, 22202, US

(21) Appl. No.: 11/650,439

(22) Filed: Jan. 8, 2007

Related U.S. Application Data
(63) Continuation-in-part of application No. 11/594,195, filed on Nov. 8, 2006.
Application No. 11/594,195 is a continuation-in-part of application No. 11/189,183, filed on Jul. 25, 2005, now Pat. No. 7,268,954.

(30) Foreign Application Priority Data
Jul. 28, 2004 (IT) MI2004A 001540
Jul. 12, 2006 (IT) MI2006A 001355

(51) Int. Cl. G06F 3/12

(52) U.S. Cl. 358/1.15

(57) ABSTRACT

The sheet handling device comprises a cutting member for cutting at least one sheet to obtain two documents therefrom, and a control member for distributing the sheets obtained in this manner by directing them towards suitable post-print document processing devices operating in direct connection with a digital sheet printer. The sheet processing device consists of printing a plurality of documents on a single sheet, cutting the sheet to separate the printed documents, and stacking the documents to form the finished complex document. Collection is achieved by stacking the documents horizontally face to face while maintaining the print sequence, with continuous production of complex documents.

This application is a continuation-in-part of my co-pending application Ser. No. 11/594,195, filed Nov. 8, 2006, which in turn is a continuation-in-part of my copending application Ser. No. 11/189,813, filed Jul. 27, 2005.

### FIELD OF THE INVENTION

This invention relates to a device and process for handling printed sheets leaving digital sheet printers, able to be directly connected in line with the printer to obtain an integrated system for printing sheets of various formats containing several single-page or multiple-page documents, and their conversion into documents by cutting them transversely to the sheet movement direction and by other operations subsequent to the transverse cut.

The handling device and process are applicable both to digital sheet printers in which the paper moves from right to left in the printer and to digital sheet printers in which the paper moves from left to right in the printer.

### BACKGROUND OF THE INVENTION

In the state of the art, those offices and departments using industrial digital printers for sheets, for example for printing employee's pay-packets, print on sheets of A4 format which, after printing, are sorted, then stacked in vertical receivers and subsequently inserted into a machine for envelope filling or for binding.

Currently, the printing cost is dependent not on the size of the printed sheet but on their number, hence for those offices which process large document quantities, the total printing costs are proportional to the quantity of sheets handled by the printers.

### DISCUSSION OF THE RELATED ART

It is very common to use industrial digital sheet printers to print documents consisting of several A4 sheets with sheet quantities variable between one document and the next in their printing sequence. Whatever their format, the printed sheets are commonly collected in receivers which stack the sheets vertically by laying them extended one on another. In order not to interrupt the printing process, when a first vertical receiver is full the A4 sheets are fed to a second vertical receiver via a bypass device of the first vertical receiver.

With current printing programs commonly used for printers, it is never possible to ensure that all the documents of variable sheet quantities are completely collected in the first vertical receiver, so that it can happen that a document has part of its sheets collected in the top of the pile of the first vertical receiver and part of its sheets in the bottom of the pile of the second receiver.

For subsequent post-print handling of the documents, whether envelope filling or binding, the documents have to be worked while maintaining them in the sequence in which they were printed.

If the machines used for envelope filling or binding were to handle the piles of sheets of the vertically collected documents as extracted by the printers which withdraw the sheets from the top of the pile, the document printing sequence would be altered and there would be the risk of not being able to complete document processing where part of the sheets have finished at the bottom of the first row of the first vertical receiver and the remaining sheets of the same document have finished at the bottom of the pile of the next vertical receiver.

The solution universally used consists of manually unloading the sheets from the various vertical receivers of the printers, taking care that the document print sequence is maintained when loading the sheets onto the sheet feeders of the envelope or binding machines. This manual procedure implies risks of error in the post-print processing stages besides a general productivity loss in the entire document processing, printing and distribution procedure.

With usual print cost debiting mechanisms based on the “click charge” concept, the cost of printing an A3 sheet is the same as the cost of printing an A4 sheet, hence the user of digital printers for sheets could print A4 page documents on A3 sheets, collect them in the usually used vertical receivers and, before passing to subsequent envelope filling or binding, divide the pile of A3 sheets into two piles of A4 sheets using industrial guillotines. However this procedure would not be practicable because all control over the sheet sequence in the documents would be completely lost.

Similar considerations also apply to sheet formats other than A4 and A3.

### SUMMARY OF THE INVENTION

An object of the present invention is therefore to provide a device and process which overcome the aforesaid drawbacks.

A particular object is to reduce the print costs and times by printing documents on A3 sheets, forming coherent A4 documents by cutting each A3 sheet along its short side, and collecting the documents in A4 format.

A further object is to simplify the feed of sheets to the envelope or binding machine by providing a process for collecting A4 documents on horizontal receivers insertable into the printing machine, which maintain the sheets in a vertical position and in the correct print sequence even if the collection of a document print flow is divided between two or more horizontal receivers.

A further object of the invention is to provide a device connectable directly to digital sheet printers upstream and to other devices and/or machines downstream of the device itself, to allow post-print operations and processes which are very flexible while at the same time enabling the digital printers to totally utilize their printing versatility towards a plurality of applications in the most varied sectors in which digital printing is used.

In particular, according to the invention the sheets being handled (of A3 or other than A3 format) can be cut in various ways for their conversion into documents (of A4 or other than A4 format) or the cutting step can be bypassed and the documents (i.e. the cut sheets) be collected differently according to specific requirements.

Another object of the invention is to provide a device and process adaptable to the downstream processes and machines.

For example, according to the invention the documents are collected in piles, the flow of these document piles being adaptable to the characteristics of the printer (which for example may not be able to accommodate frequent successive stoppages and starts) and/or to the specific needs of the downstream machines or processes which, for example, may require the sheets to be fed in a specific direction or in a predetermined manner.

These and further objects are attained according to the present invention by a device and process in accordance with the accompanying claims.

The reference to A3 and A4 formats is given by way of example only, similar considerations and advantages also applying to formats other than A3 and A4.

### BRIEF DESCRIPTION OF THE DRAWINGS

Further characteristics and advantages of the invention will be more apparent from the ensuing description of a preferred but non-exclusive embodiment of the device and process of the invention, illustrated by way of non-limiting example in the accompanying drawings, in which:

FIG. 1 shows a preferred embodiment of the device according to the invention;

FIGS. 2-5 are schematic views showing different embodiments of the process;

FIG. 6 is a schematic view of a device according to the present invention;

FIGS. 7 and 8 show two embodiments of the invention associated with document finishing machines;

FIGS. 9A-9F show an example of the implementation of the process of the invention; and

FIGS. 10, 10A, 11, 11A, 12, 12A, 13 show a storage element according to the invention in different configurations.

### DETAILED DESCRIPTION OF THE INVENTION

Current printers are controlled electronically and can print on either A4 sheets or A3 sheets, distributing the print on the sheets in the manner desired by the user.

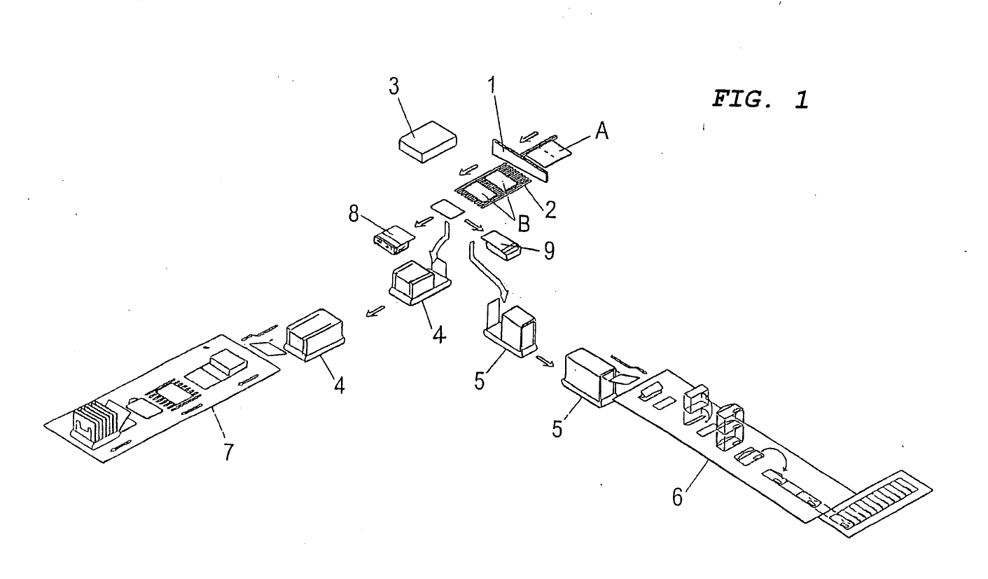

FIG. 1 shows a preferred embodiment of the device of the invention, comprising a cutting member 1 for cutting the A3 sheets A originating from a digital sheet printer (not shown) able to print on both A3 and A4 sheets, to produce from each A3 sheet two (or more than two) A4 sheets B, a conveying member 2 for the sheets, a control member 3 able to distribute the sheets by moving them to the right or left, depending on the desired collecting process, towards one or more horizontal removable receivers 4, 5 which stack the sheets vertically and are to be used as loaders for one or more manipulator machines, for example an envelope machine 6 or binding machine 7.

In an alternative configuration the sheets can be stacked horizontally by resting them one on the other on their faces.

The sheet handling device of the invention operates connected directly to the digital sheet printer, i.e. the printed sheets are directly fed to the device and handled in such a manner as to obtain a single process from printing to the finished document, i.e. with continuous production of complex documents.

The same control member 3 is able to feed the sheets cut into A4 format to two interceptor and receiver devices 8 and 9 should any irregularities occur while printing the sheets or reducing the sheets from A3 format to A4 format. Depending on the requirements of the subsequent post-print process, the sheets converted into A4 format can be stacked vertically resting either on their short side or on their long side. The receivers comprise a sheet carrier belt and a movable wall ensuring that the sheets are compacted, hence enabling them to be stacked vertically on the horizontal receivers while maintaining the correct print sequence.

The text which is to be carried on two A4 sheets is printed on one A3 sheet, resulting in both a reduction in cost, which is calculated on the basis of the number of sheets printed independently of their dimensions, and a reduction in time due to the elimination of the time required for feeding a double quantity of A4 sheets to the printer.

The A3 sheet is then cut into two A4 parts by a cutting member 1 fed by a conveying member 2.

After the printing and cutting operation, the resultant A4 sheets are inserted into a control member 3, able to shift the sheets towards the right or left, to distribute them to suitable receivers 4 and 5. These horizontal receivers 4 and 5 in which the sheets are vertically stacked, are preferably of horizontal stacking type and present the characteristic of being removable and usable as loaders for envelope machines 6 or binding machines 7. This characteristic is particularly advantageous because it enables the sheets to be inserted into the envelope machines 6 and binding machines 7 in the order in which they were printed.

FIG. 1 shows an example of a printer from which the A3 sheets are expelled along a direction from right to left, however it is apparent that the same concepts apply if the sheets are expelled along other directions, and in particular from left to right.

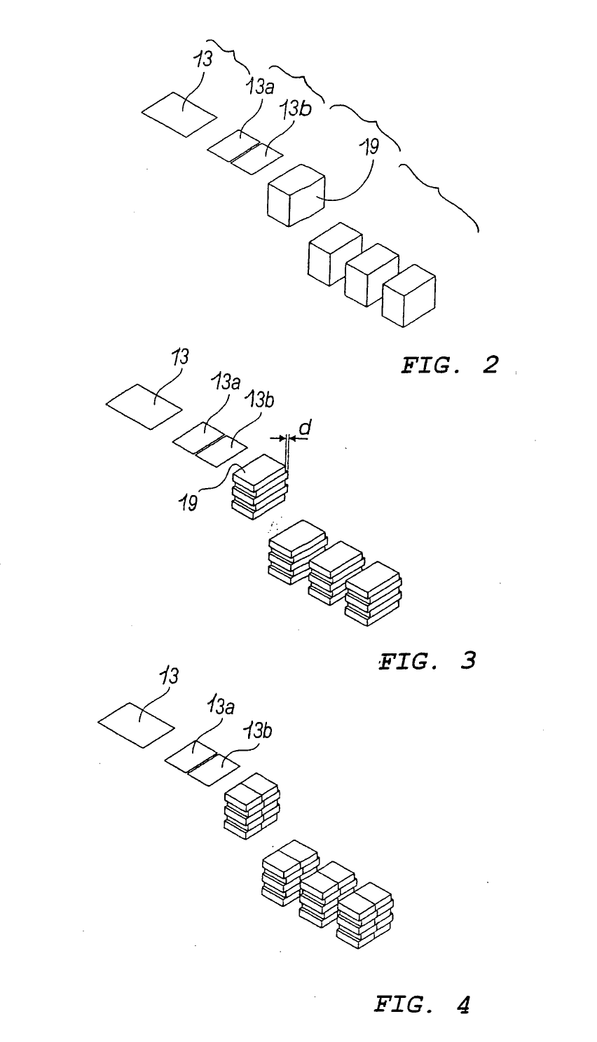

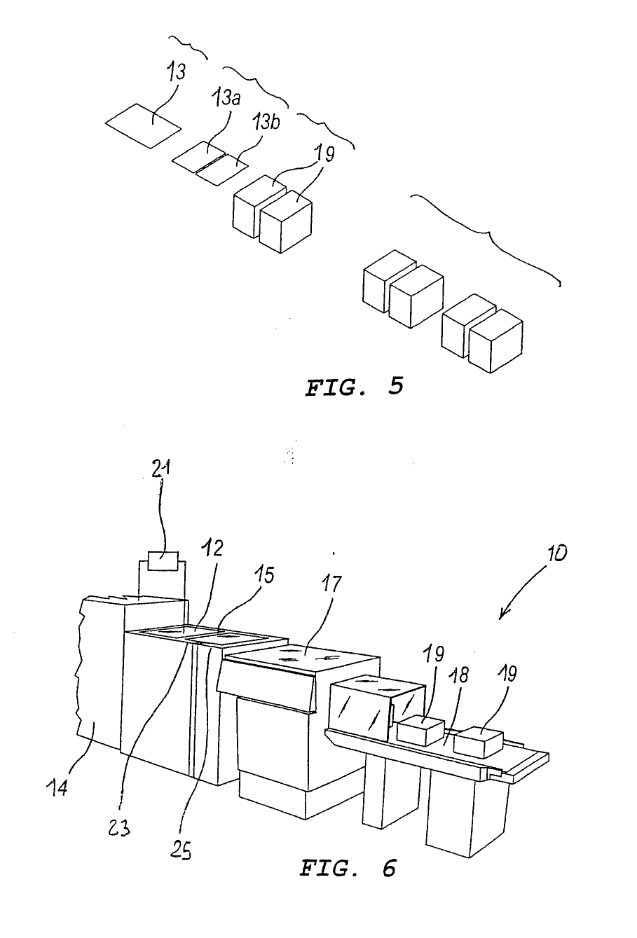

FIGS. 2-8 show further embodiments of the device of the invention.

In these embodiments the device 10 comprises a printer connection module for transporting sheets 13 with registration 12, which receives said sheets 13 from an industrial digital sheet printer 14 and feeds them to a cutter 15 (for example of rectilinear blade and counter-blade type with electronically controlled reciprocating movement) which transversely cuts (at 90° to the direction in which the sheets originating from the printer move) the sheets 13 and generates two or more documents 13a, 13b (in this description the term “document” means any sheet part which is cut, such documents 13a, 13b being able to be combined to generate complex documents comprising a plurality of pages).

From the latter (cutter 15) the documents 13a, 13b are fed to a receiver 17 which receives them, stacks them while maintaining their print sequence and transfers them to a discharge device 18.

The receiver 17 stacks the documents 13a, 13b horizontally face to face and maintained in the sequence in which they were printed; this is shown in FIG. 6 which shows three piles 19 of documents.

The cutter 15 cuts the sheets 13 into two or more parts to form documents 13a, 13b of equal or different dimensions; in particular, FIG. 2 shows an embodiment in which each sheet 13 is cut to form two equal documents 13a, 13b.

The documents can be stacked into a single pile 19 (FIG. 2), however in other examples the receiver 17 is arranged to stack the documents into two or more piles 19.

The documents 13a are all stacked into a first pile and the documents 13b are all stacked into a second pile or, alternatively, the documents 13a and 13b are all superposed into a single pile then, when this has reached the set limit, all the parts 13a, 13b are stacked into another pile.

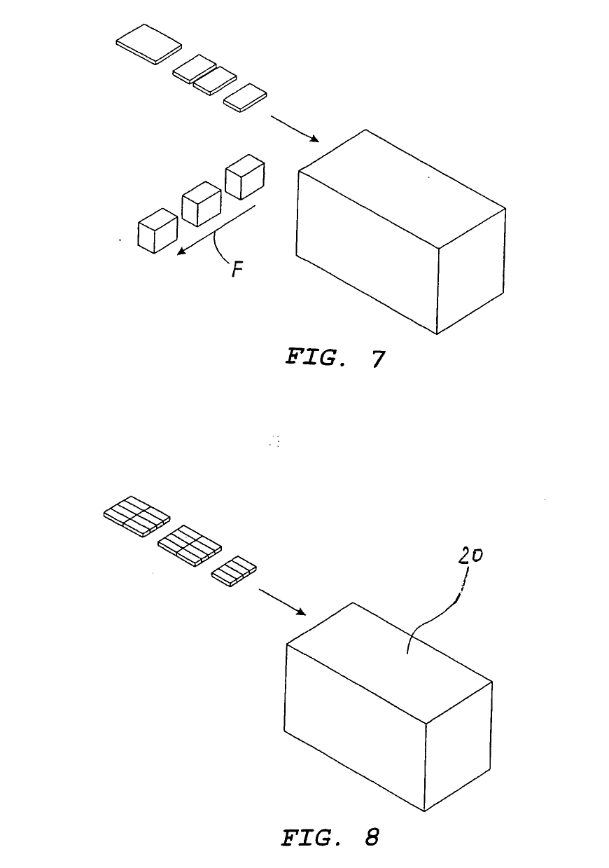

The discharge device 18 is arranged to feed the document piles in a direction aligned to the direction in which the documents 13 advance during processing or, alternatively, in a direction inclined, preferably by 90°, to the direction in which they advance during processing; this is shown by the arrow F of FIG. 7.

The device 10 comprises control means 21 interfaced with the printer 14 positioned upstream of the printer connection module for transport with registration 12; these control means 21 implement the offset function in the receiver 17 as shown in FIG. 3, in addition to controlling devices of the printer and of the device 10 to facilitate restoration of the automatic cycle after possible errors in both machines and to ensure integrity of the converted documents.

The piles of superposed documents 13a, 13b can also be fed automatically to a finishing machine 20 to implement an automatic document forming system which starting with blank or pre-printed documents enables printed documents possibly composed of several bound pages to be obtained.

In this case a conveyor is preferably provided downstream of the device 10 (after cutting by the cutter 15) to feed an automatic booklet former of type CEM series CSG (FIG. 8).

The device 10 can also comprise a trimming device 23 with one or more pairs of circular blades, to longitudinally trim the documents 13a, 13b already cut by the cutter 15; this trimming device 23 is interposed between the cutter 15 and the receiver 17.

Advantageously the device 10 comprises a longitudinal cutting device 25 for example of circular blade type, to cut the documents 13a, 13b along a longitudinal direction (in the direction in which the sheets move through the printer); the longitudinal cutting device 25 is also positioned between the cutter 15 and the receiver 17.

Advantageously, this embodiment of the device enables a continuous sheet flow to be achieved from the printer to the finishing devices by uninterruptedly forming packs of sheets and distributing them. These sheet packs are directed in the direction in which the paper flows or in a direction perpendicular thereto.

This embodiment is particularly suitable for satisfying book-on-demand requirements.

A member for intercepting and discarding defective sheets is also suitably provided (not shown), to ensure the quality of the documents produced; this device is of a type known to the expert of the art. The member is integrated into the device 10 and is positioned between the exit of the cutter 15 and the receiver 17 and comprises an intermediate collection station enabling the converted documents to be accumulated during pile discharge and offset in order not to have to temporarily halt the printer, hence allowing uninterrupted operation.

The control means 21 control the device operation and are arranged to implement bypassing of the cutter 15, to enable the sheets 13 to pass through the cutter without being cut into parts of smaller dimensions and hence be fed to the downstream processing unit without being stacked, by an additional conveyor device. Alternatively these uncut sheets can be fed to the stacking system by the already described methods.

The control means 21 enable the device to receive commands from the printer 14 and to feed the printer with data enabling the device and printer to operate in a coherent manner, including the error situations which can arise in both machines. The control means 21 can also be provided with systems for sensing control codes printed on the sheets by the printer to enable control and/or mechanical operations on the documents to be carried out.

With particular reference to those embodiments of the invention shown in FIGS. 2-8, the operation of the device is apparent from that described and illustrated, and is substantially as follows.

The printer 14 prints the desired information on the sheets 13.

For example the sheets are of A3 dimensions, the information being printed (by the digital sheet printer) on each half of the A3 sheet.

The sheets 13 are then fed, by the printer connection module for transport with registration 12, to the cutter 15 which transversely cuts the A3 sheets into two A4 sheets which are stacked by the receiver 17.

Stacking can take place by one of the previously indicated methods.

If the documents have to be further cut (for example to form documents of A5 size) the longitudinal cutting device 25 is also operated and the documents 13a, 13b are further cut longitudinally to obtain documents of the desired format.

The documents must be correctly printed on the sheet 13 fed to the printer, the subsequent cutting steps then separating each document from the others printed on the same sheet; this operation is executed flexibly and rapidly by the device of the invention.

The present invention also relates to a sheet handling process consisting of cutting the sheets 13 to separate documents 13a, 13b, collecting the cut documents 13a, 13b and stacking them to form the finished document.

In particular, the following steps are performed:
printing the text intended for two documents of A4 format onto a single sheet of A3 format;
cutting the A3 sheet into two A4 sheets;
distributing the A4 sheets to various removable horizontal receivers 4, 5 with vertical or horizontal stacking of the A4 sheets and with maintenance of the correct print sequence, or possible discarding of any blank or badly printed sheets;
intercepting and collecting sheets which are not to be fed to subsequent post-print operations.

In a particular embodiment of the process of the invention, the following steps are also provided:
disconnecting the removable receivers from the printer and connecting them to suitable envelope machines and/or binding machines;
withdrawing the A4 sheets in succession by the envelope machines and/or binding machines.

Preferably, according to the invention the documents 13a, 13b are collected by stacking them horizontally face to face while maintaining the print sequence, with continuous production of complex documents.

The sheets are divided into two or more documents of equal or different dimensions and are stacked into a number of piles.

In a first example of the process, after cutting, each of the documents 13a, 13b is stacked on a different pile. Thus enables reduced dimension documents to be printed, such as cheques or other documents, on sheets which can contain two columns of them, each column containing multiple names. By means of the invention two document piles are created, one for each of the two print columns, the documents of each pile being grouped on the basis of identical multiple names by the offset function, ready to pass to the subsequent post-print operations. A typical example is the processing of cheques or other documents to be formed into booklets by finishing machines not integrated with printers.

In another example, after cutting, all the documents 13a, 13b are stacked onto one and the same pile.

When necessary, as shown in FIG. 3, the documents 13a, 13b are stacked by implementing the offset function. This can also be done by adjusting the spread set for the documents (i.e. the dimension d) in accordance with preset parameters and in relation to the printer commands related to the sheets being printed.

According to the process the cutting step can be bypassed, to obtain at discharge not only documents with smaller dimensions than those of the initial sheets because they have been converted into documents of the required dimensions, but also documents with the initial dimensions.

According to the invention the stacking operation can also be bypassed, both for sheets on which the conversion cut is not made and also for documents resulting from conversion by single or multiple cutting of the printed sheets. This enables sheets or documents to be fed to other post-print handling systems integrated with the printer while maintaining the device of the invention interposed and operating, ready at any moment to easily pass to other applications for which its main functions are required. The conversion cutting bypass and the stacking bypass functions, if associated with a configuration of the conveying device by which the document piles are conveyed in a direction at 90° to the paper flow, give an exceptional degree of flexibility and versatility to an automatic post-print finishing system completely integrated with the printers.

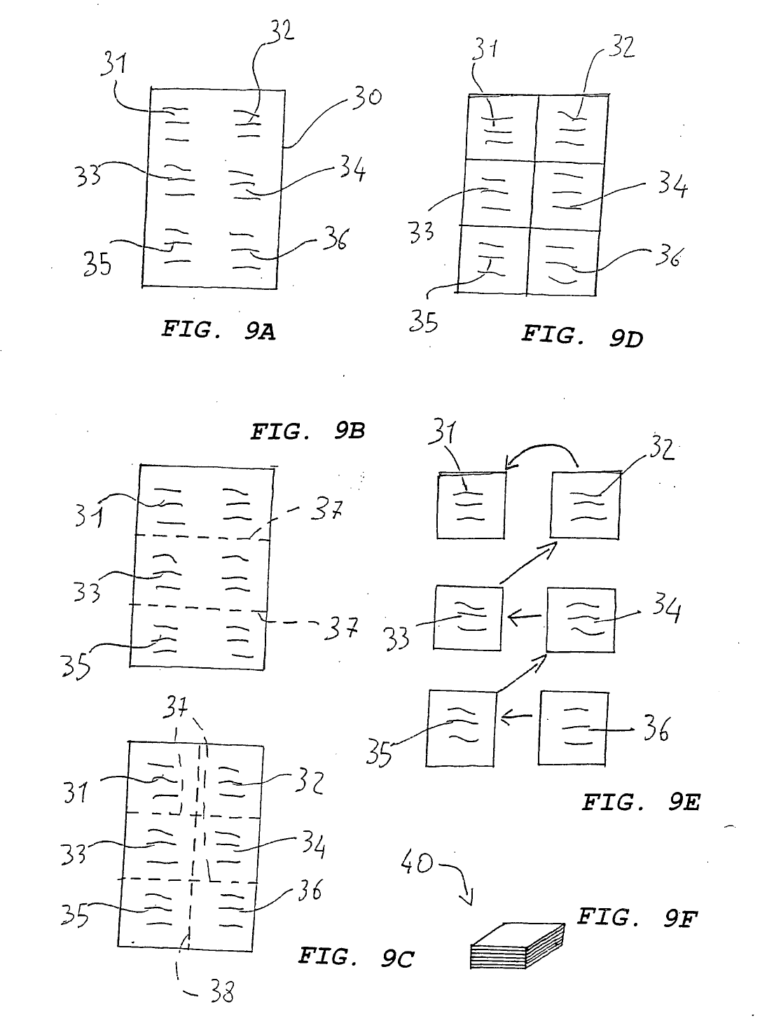

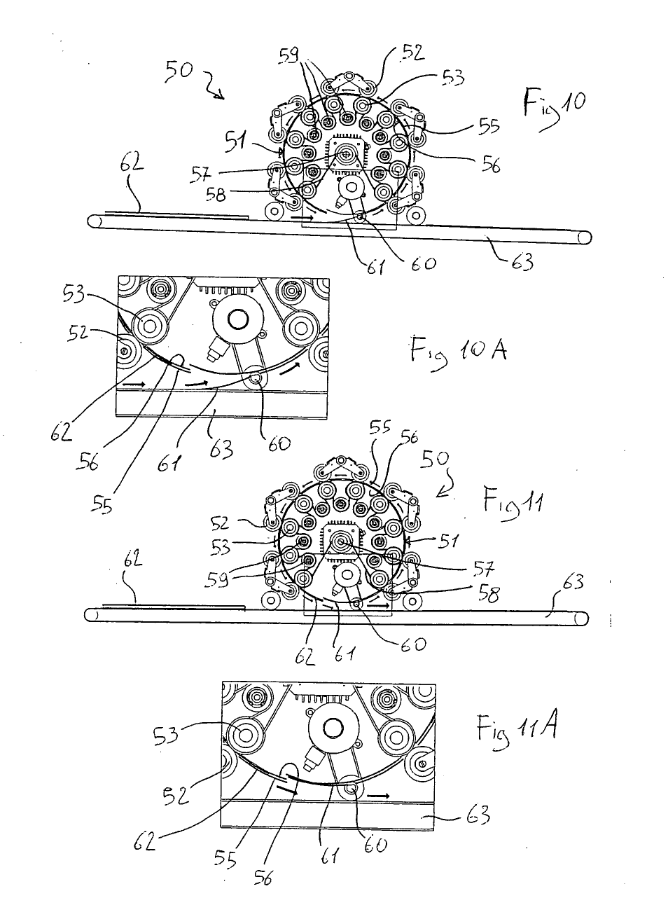

FIGS. 9A-9F show a further example of implementation of the process of the invention particularly suitable for satisfying the book-on-demand market, in which runs of even a single title (i.e. a single volume) are printed in digital format.

In this respect, a plurality of documents 31, 32, 33, 34, 35, 36 are printed on a single sheet 30 (FIG. 9A).

The transverse cuts 37 (FIG. 9B) and the longitudinal or trimming cuts 38 (FIG. 9C) are then made to separate from one another the documents 31-36 (FIG. 9D).

Finally the documents 31-36 are superposed on each other (FIG. 9E) in a prearranged scheme depending on the printing method, to form the finished complex document 40 (FIG. 9F).

This is achieved by transferring the individual documents 31-36 from left to right or from right to left, according to the print sequence, to mutually superpose them in their exact print sequence by a known device of the type described in IT 1 244 770.

In this manner piles can be formed consisting of a single complex document (book or volume), to satisfy the book-on-demand sector for one-off books.

This is particularly advantageous because the market tendency indicates that in the digital book printing sector the run make-up now tends towards a single example per run.

Advantageously, with the process of the present invention, runs subsequent to the first can be produced, each consisting of a single complex document (evidently, this is also true for the first run); in other words, those runs subsequent to the first (and also the first run) can comprise even a single volume or book.

In practice, printing is carried out such that the document J (i.e. page J) is superposed on the other documents to form the Jth document (i.e. the Jth page) of the complex document (i.e. the book or volume).

In a further embodiment of the invention the device is provided with a storage element arranged to store the documents cut and to make them allowable when required by the complex document to be realised.

The storage element is particularly useful when a number of documents (such as checks) are printed by a digital sheet printer on one and the same page; in these cases, the documents (checks) are printed usually in two columns and afterwards each document is separated from the others by cutting and is stacked.

Digital sheet printers are able to print documents in a fast fashion only if the documents which are printed have similar features, for example each page should contain only checks.

Nevertheless, it is often necessary to provide a complex document with some documents having different features from the others, for example a checks booklet may be provided with a front page, nine checks, a document for requesting a new check booklet and a further last check; finally the check booklet may be provided with a rear page.

Therefore, printing all the documents constituting each check booklet in the order in which they must be stacked slows down the printer and decreases its productivity.

To solve this drawback, the device of the invention is provided with the storage element 50.

The storage element 50 has a closed circular path 51 and is arranged to receive and store documents and to release them on request on conveyor 63.

In particular, the circular path 51 is defined by couples of rollers 52, 53 placed in circle (in order to define the circular path 51) and by curvilinear guides 55, 56 (shaped like sectors of circles) that are placed between laterally adjacent rollers.

For example, FIGS. 12 and 13 show that between the adjacent rollers 52A-52B and 53A-53B there is respectively provided a guide 55 and 56.

The rollers are rotatable and are activated by a motor 57 through a belt 58 and idle rollers 59.

The guides 55, 56 have dimension such that a document inserted in the storage element 50 is always gripped at least between a couple of rollers 52, 53.

The storage element 50 comprises means for catching in or discharge documents from it.

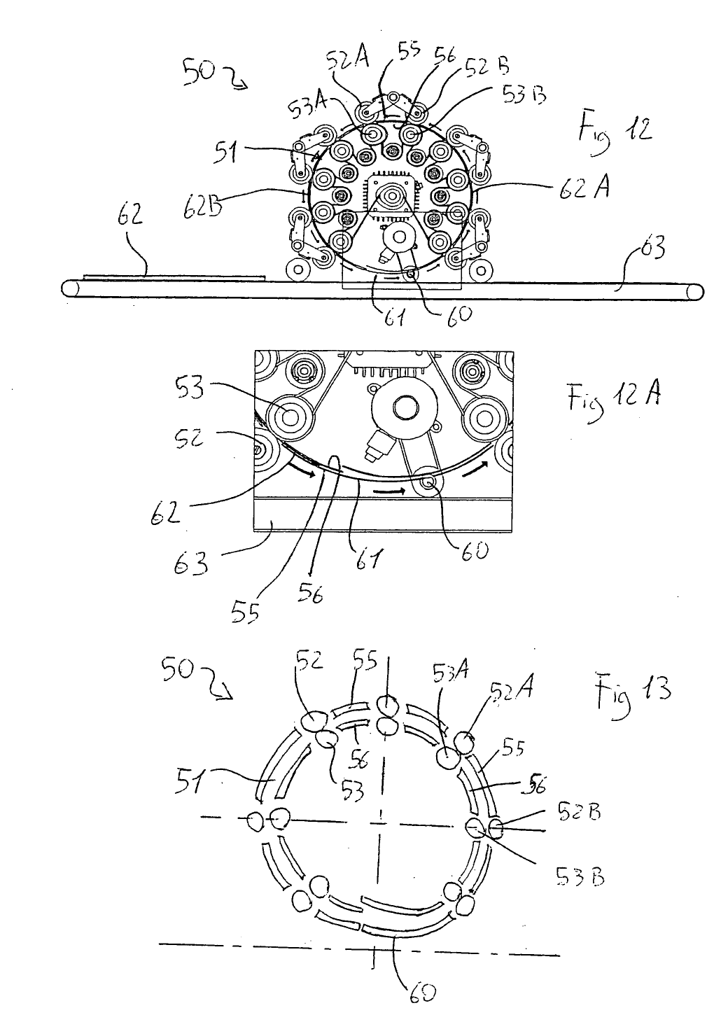

The catching/discharging means comprise (in the embodiment shown) one pivotable guide 61 (hinged in 60) arranged to be brought into a catching position (shown in FIG. 10) in which a document 62 is caught by the storage element 50, a discharge position (shown in FIG. 11) in which a document 62 is discharged by the storage element 50.

In these configurations the rollers 52, 53 are preferably activated at the same velocity of the conveyor 63, i.e. the periphery of each roller 52, 53 has the same velocity of the conveyor 63.

In addition, the pivotable guide 61 is arranged to be brought into a by-pass position (shown in FIG. 12).

In such a configuration (by-pass position) the guide 61 allows the documents stored in the storage element 50 to circulate within it and, during such movement, the documents are not caught or discharged. This allows the documents within the storage element 50 to change their position within it so as to bring a particular document in a particular position; for example (see FIG. 12) a document 62A a may be brought in the position occupied by the document 62B in order to make it ready to be discharged or may be moved to free a portion of the storage element 50 to receive a further document. In this configuration the rollers 52, 53 may rotate at a velocity independent of the velocity of the conveyor 63 (i.e. the rollers 52, 53 may be faster than the conveyor 63).

In addition, the by-pass position allows a document 62 moving on the conveyor 63 to overcome the storage element 50 without being caught by it.

It has been found in practice that the device and process of the invention are particularly advantageous because they enable documents to be formed in a vary flexible and economically convenient manner, even for very small print runs.

The device and process conceived in this manner, although applicable to all digital sheet printers of industrial type of currently known handlable format and printing speed, are susceptible to numerous modifications and variants, all falling within the scope of the inventive concept; moreover all details can be replaced by technically equivalent elements.

In practice the materials used and the dimensions can be chosen at will according to requirements and to the state of the art.

What I claim is:

1. A sheet handling device comprising a cutting member for cutting at least one sheet to obtain two sheets therefrom, and a control member for distributing the sheets obtained in this manner by directing them towards suitable post-print document processing devices operating in direct connection with a digital sheet printer.

2. A device as claimed in claim 1, wherein said control member comprises a device for intercepting and collecting sheets which are not to be fed to subsequent post-print processes.

3. A device as claimed in claim 1, further comprising at least one removable sheet receiver.

4. A device as claimed in claim 3, wherein in said receiver the sheets are stacked in a vertical position.

5. A device as claimed in claim 4, wherein said receiver for vertical stacking comprises a sheet carrier belt and a movable compacting wall.

6. A device as claimed in claim 4, wherein said receiver can be used as a loader for at least one manipulator machine.

7. A sheet handling device comprising a connection module for transporting sheets to a cutter for cutting the sheets to define documents, and a receiver for receiving the documents from the cutter and for feeding them to a discharge device, wherein said receiver is arranged to stack the documents horizontally face to face while maintaining the sequence in which they were printed.

8. A device as claimed in claim 7, wherein said cutter is arranged to cut said sheets into two or more parts to form documents of equal or different dimensions.

9. A device as claimed in claim 7, wherein said receiver is arranged to stack said documents into two or more piles.

10. A device as claimed in claim 7, wherein said discharge device is arranged to feed the document piles in a direction inclined, preferably by 90 degrees, to the direction in which the documents advance during processing.

11. A device as claimed in claim 7, comprising control means interfaced with a printer positioned upstream of said device and arranged to implement the offset function in said receiver and/or the discharge of document piles and/or the restoration of the automatic cycle after stoppages which have occurred due to errors of the printer and/or of the device.

12. A device as claimed in claim 7, wherein the piles are fed automatically to a finishing machine to implement an automatic document forming system.

13. A device as claimed in claim 7, comprising a trimming device arranged to longitudinally cut the documents already cut by said cutter, said trimming device being interposed between the cutter and the receiver.

14. A device as claimed in claim 13, wherein said trimming device comprises one or more circular blades arranged to cut the documents in a longitudinal direction.

15. A device as claimed in claim 14, wherein said trimming device with one or more pairs of circular blades is positioned between said cutter and said receiver.

16. A device as claimed in claim 7, comprising a member for intercepting and discarding defective sheets.

17. A device as claimed in claim 7, comprising an intermediate collection member positioned between the cutter and the receiver to accumulate converted documents during the receiver discharge and offset steps.

18. A device as claimed in claim 7, comprising control means for controlling its operation and for implementing bypassing of the cutting operation by the cutter and of the stacking operation by the additional conveyor device.

19. A device as claimed in claim 18, wherein said control means are provided with systems for sensing control codes printed on the sheets by the printer, to enable control and/or mechanical operations to be carried out on the documents.

20. A device as claimed in claim 1, further comprising a storage element having a closed path and arranged to receive and store documents and to release them on request.

21. A device as claimed in claim 20, wherein said circular path is defined by couples of rollers placed in circle.

22. A device as claimed in claim 21, wherein said circular path is defined by curvilinear guides placed between laterally adjacent rollers.

23. A device as claimed in claim 21, wherein said rollers are rotatable and are activated by at least a motor.

24. A device as claimed in claim 20, wherein said storage element comprises means for catching in or discharging documents from it comprising at least a pivotable guide arranged to be brought into a catching position in which a document is caught by the storage element, a discharge position in which a document is discharged by the storage element, a by-pass position in which a document may move in the storage element or may move on a conveyor overcoming the storage element without being caught or discharged by it.

25. A sheet handling process, consisting of printing a plurality of documents on a single sheet, cutting the sheet to separate the printed documents and stacking the documents to form the finished complex document.

26. A process as claimed in claim 25, wherein
the documents not to be fed to subsequent post-print processes are intercepted;
the documents are distributed to horizontal receivers with vertical stacking in which A4 format documents are stacked resting on their long side or short side.

27. A sheet handling process as claimed in claim 25, wherein A3 format sheets are cut in half to obtain A4 format sheets.

28. A sheet handling process as claimed in claim 26, wherein after distribution, the documents are stacked in suitable removable receivers.

29. A sheet handling process as claimed in claim 28, wherein the removable receivers are removed for use as loaders for manipulator machines.

30. A sheet handling process consisting of cutting the sheets to separate the documents, collecting the cut documents and making them available for subsequent processing, wherein collection is achieved by stacking the documents horizontally face to face while maintaining the print sequence, with continuous production of complex documents.

31. A process as claimed in claim 30, wherein said sheets are divided into two or more documents of equal or different dimensions.

32. A process as claimed in claim 31, wherein said cut documents are stacked into single or multiple piles.

33. A process as claimed in claim 31 wherein after cutting, each of the documents is stacked on a different pile.

34. A process as claimed in claim 31, wherein after cutting, all the documents are stacked on the same pile.

35. A process as claimed in claim 31, wherein the documents are stacked by implementing the offset function.

36. A process as claimed in claim 30, wherein the cutting step is bypassed.

37. A process as claimed in claim 30, wherein the stacking step is bypassed.

38. A process as claimed in claim 30, wherein successive runs of complex documents are produced, each consisting of a single complex document.

39. Storage element for temporary storing document under working in a document production line has a circular path and is arranged to receive and store documents and to release them on request.

40. Storage element as claimed in claim 39, wherein said circular path is defined by couples of rollers placed in circle.

41. Storage element as claimed in claim 40, wherein said circular path is defined by curvilinear guides placed between laterally adjacent rollers.

42. Storage element as claimed in claim 40, wherein said rollers are rotatable and are activated by at least a motor.

43. Storage element as claimed in claim 39, further comprising means for catching in or discharging documents from it comprising at least a pivotable guide arranged to be brought into a catching position in which a document is caught by the storage element, a discharge position in which a document is discharged by the storage element, a by-pass position in which a document may move in the storage element or may move on a conveyor overcoming the storage element without being caught or discharged by it.
